(19) United States
(12) Patent Application Publication
(10) Pub. No.: US 2012/0101755 A1
(43) Pub. Date: Apr. 26, 2012

(54) VEHICULAR BATTERY PACK

(75) Inventor: Hidefumi HIRASAWA, Toyohashi-city (JP)

(73) Assignee: DENSO CORPORATION, Kariya-city (JP)

(21) Appl. No.: 13/211,607

(22) Filed: Aug. 17, 2011

(30) Foreign Application Priority Data
Oct. 21, 2010 (JP) 2010-236741

(51) Int. Cl. G06F 19/00

(52) U.S. Cl. 702/63

(57) ABSTRACT

A battery pack includes a battery module that charges and discharges electricity to be used to drive a vehicle, and a monitoring controller for monitoring charge of the battery module. The monitoring controller stores past charge records and past discharge records in a charge-discharge history. Based on an analysis of learning data of a charge-discharge cycle in the charge-discharge history, the monitoring controller determines a charge operation, which may either be a normal charge or a quick charge, for charging the battery. The normal charge provides a charging electric current per unit time that is less than the charging current per unit time of the quick charge.

### CROSS REFERENCE TO RELATED APPLICATION

The present application is based on and claims the benefit of priority of Japanese Patent Application No. 2010-236741, filed on Oct. 21, 2010, the disclosure of which is incorporated herein by reference.

### FIELD OF THE DISCLOSURE

The present disclosure generally relates to a vehicular battery pack comprising batteries that are chargeable and dischargeable.

### BACKGROUND INFORMATION

A conventional technique of charging a vehicular battery, is disclosed in Japanese Patent 2007-221900 (JP '1900). The technique disclosed in JP '1900 accurately manages a battery life of an intelligent battery pack that is equipped with a microcomputer and various sensors, based on monitoring the charge-discharge conditions and/or the number of re-charge times of the battery, Further, the battery packs used in a notebook computer (i.e. a note PC hereinafter) and the like regularly transmit various kinds of data to a management server in a battery management center, with those data identified by a unique ID of each battery pack. The management server predicts damages and life expectancy of the battery pack, based on the management and analysis of information derived from those data. That is, when the damage or the life of the battery pack is predicted, the management server can transmit a warning to a user of the battery pack used in the note PC, and can prevent a breakdown of the note PC operating on that battery pack by the user to perform a preventive replacement of the battery pack.

The battery life of a battery pack that serves as a power source of a note PC or the like may not be affected by the relatively frequent charges by a commercial power supply, or by the amount of charged electric power or by the number of quick charge. However, when the battery pack is used in a vehicle as its driving power source, the battery life may substantially be affected by a charge method, because the battery pack is assumed to be charged day to day, by a comparatively large amount of electric power.

### SUMMARY OF THE DISCLOSURE

In view of the above and other problems, the present disclosure provides a vehicular battery pack that reduces the number of quick charges for a longer battery life.

In an aspect of the present disclosure, a vehicular battery pack includes: a battery that provides electric power to a vehicle; a control unit that stores a charge record and a discharge record in a charge-discharge history of the battery, and the control unit determines a charge operation of the battery based on an analysis of the charge-discharge history. The control unit determines the charge operation to either be a normal charge or a quick charge, the quick charge is different from the normal charge, and the normal charge provides a charging electric current per unit time that is less than the charging current per unit time of the quick charge.

According to the above configuration, by employing a learning function that analyzes learning data stored in the charge-discharge history about the charge-discharge cycle, the vehicular battery pack by itself accurately determines whether or not the quick charge is required. The charge scheme of the present disclosure is highly advantageous when the charging pattern performed by the user has a highly cyclic characteristic, As a result, the number of unnecessary quick charges of the battery pack is reduced, thereby improving the battery life, and contributing to the charge cost reduction and to load reduction to an electricity supply infrastructure.

According to the present disclosure, the control unit at least communicates with a vehicle operation management server that manages an operation reservation data regarding a future operation of the vehicle. The control unit also analyzes the charge-discharge history and the operation reservation data acquired from the vehicle operation management server in order to determine the charge operation.

According to the above configuration, the vehicular battery pack determines whether the quick charge is required based on the analysis of the charge-discharge cycle data and the operation reservation data regarding the future vehicle operation that are acquired through communication with the vehicle operation management server. Therefore, the battery pack can appropriately handle a situation such as an unplanned use of the vehicle, which can not be predicted by an analysis base determination that only uses past operation data regarding the charge-discharge cycle.

According to the present disclosure, the control unit determines whether the quick charge is required based on an analysis of (a) time to a next planned use according to the operation reservation data and (b) a remaining electric charge in the battery.

According to the above configuration, (a) in case that the required electric power can be charged in the battery by the time of the next planned use, the normal charge is determined to be performed, and (b) in case that the required electric power cannot be charged in the battery by the time of the next planned use, the quick charge of the battery is determined to be performed. Therefore, for both of a predictable case and an unpredictable case the next planned use is, an unnecessary quick charge is prevented, and the quick charge of the battery pack is performed only for a required occasion.

According to the present disclosure, the control unit transmits a charge monitoring data to a responsible organization, wherein the responsible organization determines a degree of degradation of the battery.

According to the above configuration, by transmitting the degradation index of the battery to the responsible organization from an “intelligent” battery pack, the responsible organization such as a battery manufacturer, for example, is enabled to perform a battery life analysis and/or a trouble prediction analysis, thereby enabling a timely/suitable maintenance of the battery pack. Further, the responsible organization is enabled to accurately predict the battery life and the battery trouble.

According to the present disclosure, wherein the control unit performs the quick charge upon acquiring a quick charge request from a user of the vehicle, even when the control unit determines that the quick charge is not required. According to the above configuration of the battery pack, even when the quick charge is not required (i.e. negatively determined), which is based on an evaluation of the charge-discharge history, the quick charge is performed in a manner that reflects the user intention. Therefore, the quick charge of the battery pack is performed by prioritizing user intention when the user is in a quick charge required situation, thereby satisfying the user requirements. Further, a longer battery life is enabled by preventing unnecessary quick charge, when, for example, the user does not request for the quick charge.

### BRIEF DESCRIPTION OF THE DRAWINGS

Objects, features, and advantages of the present disclosure will become more apparent from the following detailed description made with reference to the accompanying drawings, in which:

FIG. 1 is an illustration of a system configuration including a vehicular battery pack and an external server in accordance with the present disclosure;

FIG. 2 is a flowchart of a control procedure performed at a time of charging the vehicular battery pack in the first embodiment;

FIG. 3 is a graphical representation of learning data of a charge-discharge cycle of the vehicular battery pack;

FIG. 4 is an illustration of a charge monitoring data of the vehicular battery pack;

FIG. 5 is a flowchart of a control procedure performed at the time of charging the vehicular battery pack in a second embodiment; and

FIG. 6 is an illustration of a vehicle reservation schedule.

### DETAILED DESCRIPTION

In the following, embodiments of the present disclosure are described with reference to the drawings. Like numbers refer to like parts in those embodiments, and like parts in the later embodiments are saved from the explanation for brevity. Combination of two or more embodiments is at least partially allowed with or without explicit description, unless otherwise specified.

### FIRST EMBODIMENT

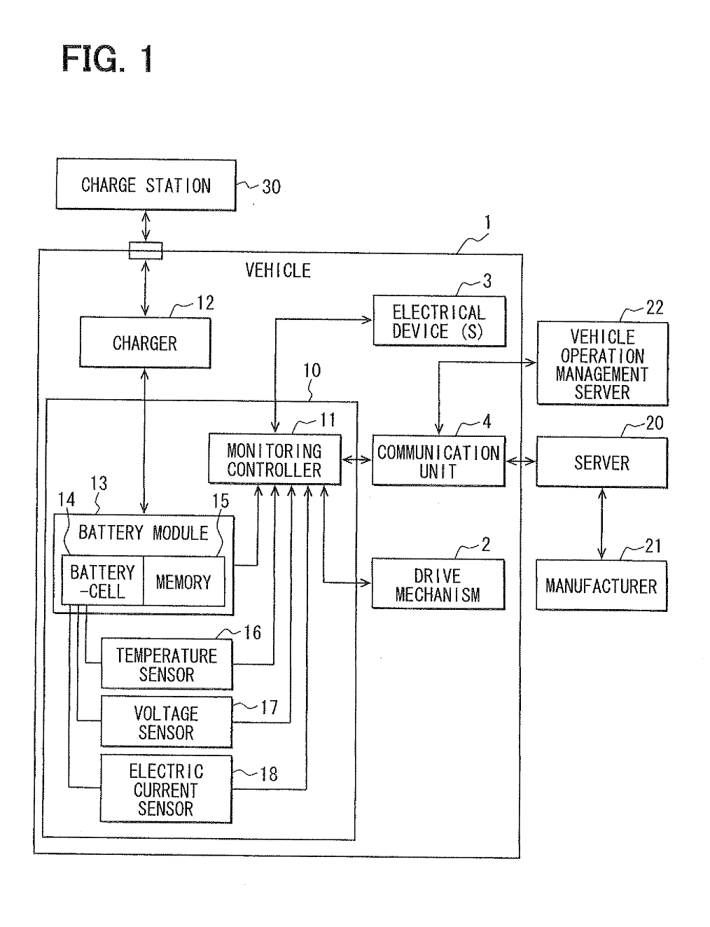

With reference to FIG. 1, a block diagram of a vehicle 1 that includes a battery pack 10 is shown. The vehicle 1 may be an electric vehicle that is powered by an electric motor or it may be a hybrid vehicle powered by both an electric motor and an internal combustion engine.

The battery pack 10 includes a plurality of battery modules 13 where each battery module 13 includes a battery cell 14 and a memory unit 15. The battery modules 13 are replaceable. The battery cell 14 is a basic component as the battery. For example, the battery cell 14 may be a lithium ion battery. In addition, the battery cell 14 and the memory 15 are structured to be inseparable without breaking the battery module 13.

The battery pack 10 further includes a temperature sensor 16 that measures the temperature of the battery cell 14, a voltage sensor 17 that measures the output voltage of the battery cell 14, an electric current sensor 18 that measures an electric current of the battery cell 14 when the battery cell 14 is charging or discharging, and a monitoring unit 11 that serves as a control apparatus or a control unit that monitors the charging and discharging of the battery modules 13.

The vehicle 1 also includes a drive mechanism 2, a charger 12, a communication unit 4, and a variety of electrical devices 3. The drive mechanism 2 includes an electric motor that drives the vehicle 1, and is powered by the electricity from the battery modules 13. Further, the drive mechanism 2 may include an internal combustion engine that may also generate a driving power for the travel of the vehicle 1.

The charger 12 of the vehicle 1, controls the charging of the battery module 13. When the vehicle 1 is connected to a charge station 30 by a cable, the charger 12 controls charge from the charge station 30 to the battery cell 14. The charger 12 has a breaker function that allows or prohibits charge to the battery cell 14 according to an external signal. The charger 12 has a charge amount control function for controlling the amount of charged electricity of the battery cell 14 to a value between a minimum charge amount and a full charge amount according to a signal. The charge station 30 includes a charge device in the vehicle 1 having a function for charging the battery cell 14, and data communication unit that communicates with the communication unit 4 of the vehicle 1. The charge station 30 is capable of performing both a quick charge and a normal charge, as a dual-purpose charge station.

The communication unit 4 communicates with external servers, towers, and the like. The communication unit 4 is configured to wirelessly communicate with a server 20. The communication unit 4 transmits data to the server 20, which is stored in a storage device of the server 20. Along with wireless communication, the communication unit 4 may also communicate with a device through non-wireless communication methods such as a cable. For example, the communication unit 4 may communicate with the data communication unit of the charge station 30 via a cable or wire connection.

The electronic device 3 of the vehicle may include an interior lights, a navigation system, audio system, turn signal, air conditioning system, or the like. Such devices are operated by electricity and receive power from the vehicle 1.

External facilities related to the vehicle 1 may include the charge station 30, the server 20 for centralized management at an external site, and a manufacturer 21 that manufactures the battery cell 14 or the like. As mentioned earlier, the server 20 wirelessly communicates with the communication unit 4 of the vehicle 1. The server 20 may include the storage device, a battery assessment unit, and is equipped with a data communication device to communicate with the manufacturer 21. The storage device of the server 20 stores various data such as vehicle data from the vehicle 1 and station data from the charge station 30, as well as, analysis result data outputted by the battery assessment unit. Data in the storage device of the server 20 can be read and used by the manufacturer 21.

The monitoring controller 11 is a microcomputer with a computer readable storage medium, serving as a control unit. The storage medium stores a program that is read by a computer. The storage medium may be provided as a memory device. The program, when executed by the control unit, controls the monitoring controller 11 to be serving as an apparatus explained in this detailed description, and to execute a control method explained in this detailed description. The monitoring controller 11 includes a memory unit, an authentication unit and an arithmetic unit, which are realized as a circuit and a program of the microcomputer.

The storage medium of the monitoring controller 11 includes a charge-discharge history. The charge-discharge history stores a record of the charge and discharge of the battery module 13 for a predetermined period of time, and is utilized as a history of the charge and discharge of the battery module 13. The charge-discharge history is continuously updated and serves as a learning data of the charge-discharge cycle. The learning data of the charge-discharge cycle is analyzed by the monitoring controller 11 during a charge control in order to determine a charge method, which may also be referred to as a charge operation. The process followed by monitoring controller 11 is discussed in detail later.

The monitoring controller 11 of the battery pack 10 is in communication with the battery module 13, the temperature sensor 16, the voltage sensor 17, the current sensor 18, the drive mechanism 2, the communication unit 4, and the electrical devices 3. The monitoring controller 11 regulates the use of the battery modules 13 by controlling the battery cell 14, the drive mechanism 2 and the charger 12. The monitoring controller 11 performs the above control based on the state of the battery cell 14. The state of the battery cell 14 can be determined by the data provided by the temperature sensor 16, the voltage sensor 17, and the electric current sensor 18. Additional sensors may also be used to measure other characteristics of the battery cell 14. Additionally, the monitoring controller 11 performs a battery authentication process; a charge control process to determine if a quick charge or a normal charge should be performed; and a transmission operation for transmitting a charge monitoring data to the external server 20 for evaluation of battery degradation.

The normal charge is a method of charging the battery cell 14 where a charging electric current per unit time is controlled to be less than a charging electric current of the quick charge, which requires a longer charge time than the quick charge. For example, the normal charge may take 10 hours to bring the battery cell 14 to full charge, while the quick charge may take 30 minutes to 2 hours for a full charge. If the battery cell 14, having a capacity of 12V/10 Ah, is charged, charging it from state of discharge to full charge by an electric current of 1 A corresponds to the normal charge that take 10 hours, and charging it from state of discharge to full charge by an electric current of 10 A corresponds to the quick charge that takes 1 hour.

Since the charging electric current of the quick charge is greater than the charging electric current of the normal charge, a heavier load is placed on the battery cell 14 during the quick charge than the normal charge. Thereby decreasing the number of time of the battery cell 14 can be re-charged, which serves as an important battery capacity index and accelerating degradation of the battery modules 13. The quick charge may also cause a heavier load on electrical power grids or infrastructures. By reducing the number of quick charges the battery life of the battery modules 13 may be extended and the load placed on electrical power infrastructures may be reduced.

The battery pack 10 is an “intelligent” battery pack which has a microcomputer, various sensors and the like. The battery pack 10 has a capability of learning charge-discharge cycle patterns based on a clock and calendar function of the microcomputer.

The memory 15 of the battery module 13 stores information that is used to authenticate the battery module 13. The stored information may include identification information (ID) and management information of the battery module 13. The identification information may include a code showing that the battery module 13 is a compliant battery and a code showing that the battery module 13 is distributed to an authorized distribution channel. The management information provides information defining a compliant use of the battery module 13 in a compliant manner. In the management information may include conditions such as the maximum number of charge times, a charge condition, a discharge condition, or the like. The memory 15 also stores security information regarding the battery.

A compliant battery may be a battery specified by a manufacturer or a seller of the vehicle 1. Further, the compliant battery may be a battery specified by both a manufacturer of the vehicle 1 and a manufacturer of the battery cell 14 as a battery for the vehicle 1. In addition, the compliant battery may mean a battery specified as usable in the vehicle 1 by at least a manufacturer of the vehicle 1 or a manufacturer of the battery cell 14 or both. The compliant battery may include a near-genuine battery that is specified by a public organization, or a near-genuine battery that is specified by an organization that includes, as organization members, manufacturers and the like. In other words, the compliant battery may not simply be a marking of a genuine product. That is, when a battery is “compliant,” there are various cases such that the battery is a genuine one, is a functionally-proper one, is a legally-acquired one, or the like. The compliant battery can be authenticated by a computer in the vehicle 1 or by an external server such as the server 20.

### Charge Control of the Present Disclosure

When the charging is performed, the charge control for charging the battery is determined and performed based on (a) an analysis of the learning data of the charge-discharge cycle stored in the charge-discharge history, and (b) a determination of whether or not a quick charge is required. In this manner, unnecessary quick charge is prevented.

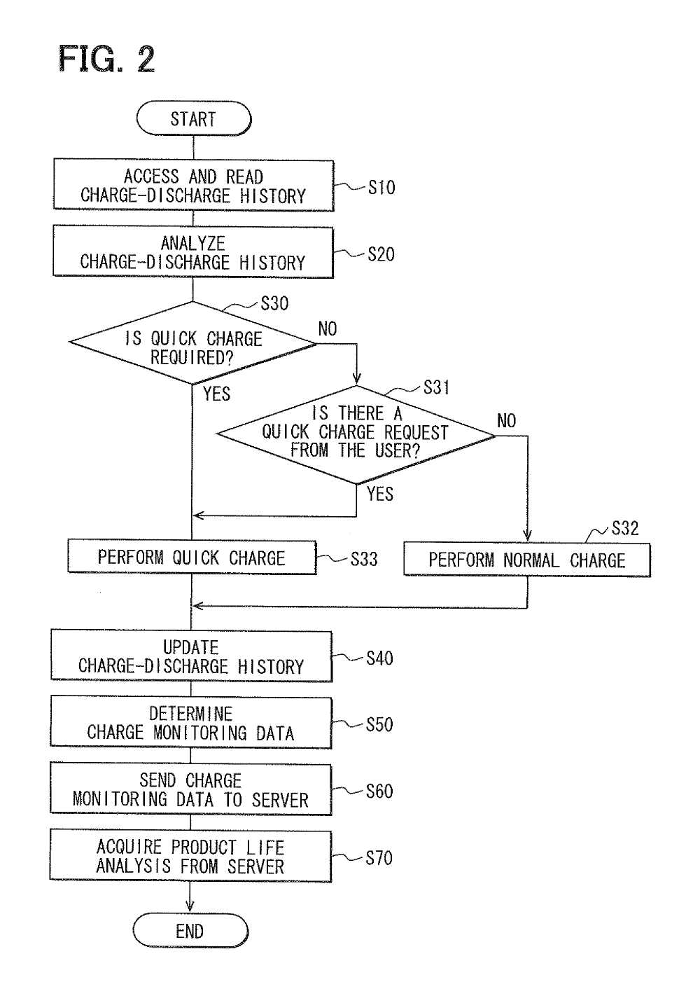

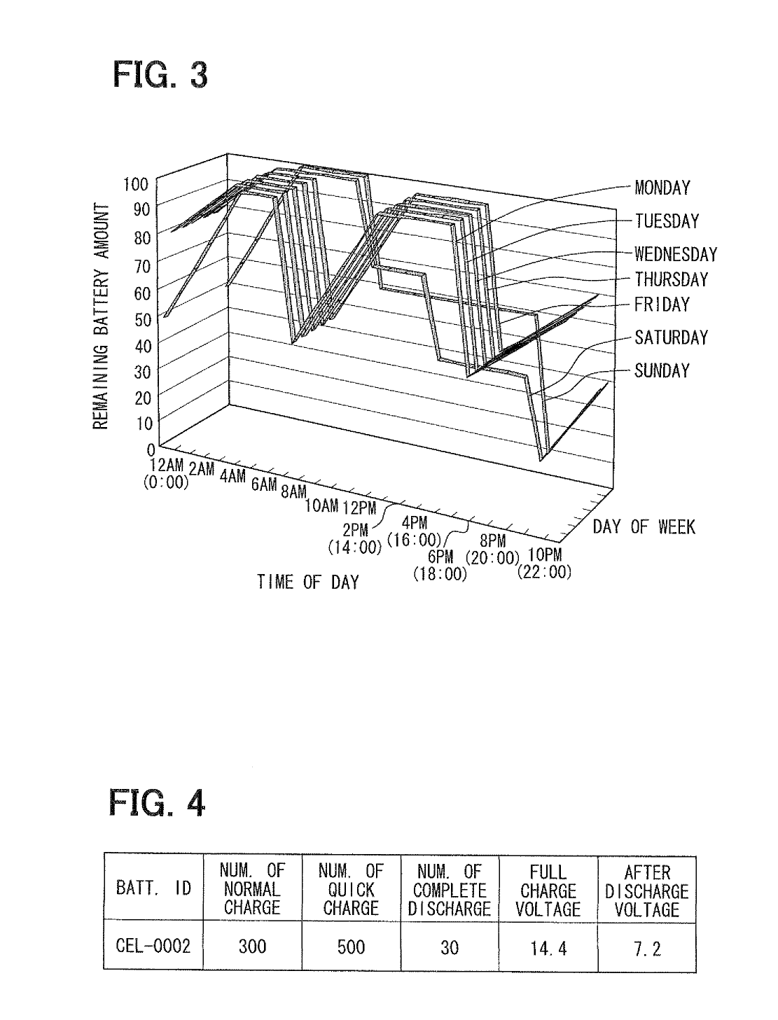

With reference to FIGS. 2 and 3, a process to determine and perform a charge method is explained. FIG. 2 is a flowchart of a control procedure performed by the battery pack 10 at a time of charging, and FIG. 3 is a graphical representation of one-week learning data of a charge-discharge cycle of the battery pack 10 stored in a charge-discharge history of the battery pack 10.

The monitoring controller 11 of the battery pack 10 performs the process shown in FIG. 2. When the battery cell 14 of the vehicle 1 is in a chargeable state, meaning it is about to be charged, the process of FIG. 2 is carried out. The vehicle 1 may be considered to be in a chargeable state when the vehicle 1 is parked or is stopped, and when a plug of the charge station 30 is connected to a socket of the vehicle 1, where the socket may be considered as a compliant electricity receiving device. Once the vehicle 1 is in a chargeable state, the process proceeds to step S10 where the learning data stored in the charge-discharge history of the storage medium is accessed and read. FIG. 3 is an example of a charge-discharge cycle for a period of week, which is stored in the charge-discharge history. FIG. 3 shows the amount of electric power remaining in the battery modules 13 of the vehicle 1 versus the time of day for each of the days of the week (Monday-Sunday).

Based on the data provided in the charge-discharge history, the process in step S20 analyzes the data to determine when the next discharge will occur. The next discharge reflects the next time the user will use the vehicle 1. The process in step S30 then determines whether a quick charge is required. Specifically, based on the amount of time remaining before the next discharge (i.e. before the next use), the process determines the charge method (i.e. a normal charge or a quick charge) that would charge the battery module 13 within the time period calculated in step S20.

For example, when the remaining charge time before the next discharge is calculated as three hours, the charge method is set to the quick charge, because the normal charge cannot charge the required amount of electricity in three hours. Alternatively, when the remaining charge time before the next discharge is calculated as ten hours and the required electricity is chargeable in 1 hour by the quick charge and is chargeable in 8 hours by the normal charge, the normal charge is performed. That is, in step S30, if both the quick charge and the normal charge can charge the required amount of electricity within the specified time (i.e. before the next discharge or use), the charge method is set to the normal charge. When the quick charge is the only option for charging the required amount of electricity in the specified amount of time, the charge method is set to the quick charge.

When the quick charge is determined as the appropriate charge method (i.e. the quick charge is required) in step S30, the process, in step S33, transmits an instruction signal to perform the quick charge to the data communication equipment of the charge station 30. Furthermore, in step S40, data about the current quick charge is saved in the charge-discharge history, and the charge-discharge history is updated.

When it is determined that the quick charge is not required in step S30, the process, in step S31, determines whether a user of the vehicle sent a quick charge instruction. The quick charge instruction is transmitted as a signal that represents the user's intention and request for the quick charge. Such a request can be inputted by the user through an operation panel located in the vehicle 1, for example a display unit on the dashboard, or an operation panel at the charge station 30, for example a display unit located on or near the charge device; or an operation panel of another device. When the quick charge instruction is detected in step S31, the process proceeds to step S33 where an instruction signal to perform the quick charge is transmitted to the data communication equipment of the charge station 30. The quick charge is performed as an appropriate charge method, and thereby giving a priority to the user's request for a quick charge. Further, in step S40, data about the current quick charge is recorded in the charge-discharge history, and the charge-discharge history is updated.

When the quick charge instruction is not detected in step S31 the process, in step S32, performs the normal charge as an appropriate charge method, and transmits an instruction signal to perform the current normal charge to the data communication equipment of the charge station 30. Further, in step S40, data about the normal charge is recorded in the charge-discharge history, and the charge-discharge history is updated.

After an update process of the charge-discharge history in step S40, the process, in step S50, determines the charge monitoring data, which is used to evaluate a degree of degradation of the battery, and stores the a charge monitoring data in the memory 15 of the battery module 13. With reference to FIG. 4, the charge monitoring data includes information regarding a full charge voltage, an after-discharge voltage, the number of normal charge times, the number of quick charge times, and the number of complete discharge times. As the charge monitoring data, the number of normal charge times, the number of quick charge times, and the number of complete discharge times are respectively counted as a total count from the first use of the battery. Further, in case that the past charge monitoring data are stored in the storage medium of the monitoring controller 11 or in the server 20, the monitoring controller 11 may be configured to calculate and predict the charge monitoring data for a new evaluation period.

In step S60, the battery pack 10 transmits the charge monitoring data, the management information, and the identification information (ID) of the battery module 13 to the outside server 20 through the communication unit 4. The information provided to the outside server 20 is used to update the stored data in the storage device of the server 20. By utilizing the management information of the battery module 13, the battery assessment unit of the server 20 performs an analysis regarding a battery life prediction and a trouble prediction. The analysis of the battery life prediction and the trouble prediction may be conducted as a comparison and analysis of the degree of performance degradation between the subject battery and an average (i.e. a standard) battery.

For example, based on the ID and management information of the battery module 13, when the number of recharge, which is the number of times each of the batteries may be rechargeable, is defined as 1000 normal charges or 800 quick charges, the remaining number of recharge is reduced. One normal charge (NC) reduces the remaining number of normal recharges by one, while one quick charge (QC) reduces the remaining of normal recharges by 1.25 (1.25=1000 NC/800 QC). Therefore, based on the charge monitoring data of FIG. 3, after a total of 300 normal charges and a total of 500 quick charges, the battery assessment unit of the server 20 determines the remaining number of recharges for a normal charge to: permitted number of NC recharge−((number of NC performed×1)+(number of QC performed×1.25))=number of remaining recharge for a normal charge. Using the numbers above: 1000−((300×1)+(500×1.25))=75 remaining recharges for a normal charge. Thus, the remaining life cycles or the remaining number of times a normal charge can be performed is 75. Similarly, the number of remaining recharges for a quick charges may also be determined. For example, one quick charge will reduce the number of remaining quick charges by 1, and one normal charge will reduce the number of remaining quick charges by 0.8 (800 QC/1000 NC). Thus the remaining number of quick charges can be determined to be: 800−((300×0.8)+(500×1))=60. Thus, the remaining life cycles or the remaining number of times a quick charge can be performed is 60.

In step S70 of the process in FIG. 2, the server 20 transmits the battery life prediction or the trouble prediction, which is the results of the above analysis, to the battery pack 10 and/or to the manufacturer 21. The results may be transmitted as required by the process or at thereby enabling the monitoring controller 11 to acquire a current battery state before finishing the charge control. As a result of receiving the above analysis, the user or the manufacturer 21 can take required maintenance steps for replacing the battery or the like, thereby securing a safe and comfortable use of the product. Step S70 may not necessarily be performed because, even without step S70, the manufacturer 21 may contact the user for notifying him/her that maintenance is required. Further, the analysis by the server 20 regarding the battery life prediction and the trouble prediction may be configured to be usable and retrievable by the manufacturer 21 at any time on demand.

The advantageous effects of the battery pack 10 in the present embodiment are explained in the following. The battery pack 10 includes the battery module 13 for charging and discharging electricity for driving the vehicle 1 and the monitoring controller 11 to control the charging of the battery module 13. The monitoring controller 11 stores the past charge records and the past discharge records to the charge-discharge history of the storage medium, and, upon having a charge request, performs a quick charge determination of whether or not to perform the quick charge based on an analysis of the learning data of the charge-discharge cycle saved in the charge-discharge history. If it is determined positively that the quick charge is required in the above determination, the monitoring controller 11 performs the quick charge, and if it is determined negatively about the requirement, that is the quick charge is not required, the normal charge is performed with the charging electricity current controlled to be smaller per unit time than the charging electricity current of the quick charge.

The battery used for driving the vehicle is expected to have a large capacity, and is expected to be charged and discharged relatively frequently. Assuming that the use pattern of the vehicular battery closely reflects the life cycle and other factors of the vehicle user, the use pattern of the battery should form a highly predictable and repeatable charge-discharge cycle for a time period of one week, two weeks, every other week, one month or the like.

Therefore, the battery pack 10 of the present embodiment, which learns and analyzes the data of the user-specific charge-discharge cycle, is enabled to predict the amount of time the user may have to charge the battery (i.e., a reservable charging time) before the next discharge (i.e. before the next time the vehicle is used). When the chargeable time allows the required amount of charging by the normal charge, the quick charge is prevented or avoided to reduce the load to the battery, and for the longer battery life. That is, by preventing the unnecessary quick charge, the battery life is elongated, and charging cost and charging load paced on the electric power grid infrastructure are reduced. The above-described battery pack 10 contributes to a peak cut of the electricity consumption for charging the battery.

Further, for example, the monitoring controller 11 may transmit the charge monitoring data to evaluate the degree of degradation of the battery to a responsible organization(s). A responsible organization may be an organization that has some connection or association with the battery, such as manufacturers of the battery, manufacturers of the vehicle or the like. The battery pack 10, which includes a controller, is able to communicate and transmit the charge monitoring data of the battery to the responsible organization(s). The responsible organization(s) then perform a battery life analysis and a trouble prediction analysis, thereby enabling a timely maintenance of the battery. Further, a highly accurate product life prediction and a trouble prediction are realized by the responsible organization, thereby enabling the user to use the product more safely and comfortably.

Further, if a user requests or instructs the performance of a quick charge, the monitoring controller 11 performs the quick charge even when it is determined that a quick charge is not required. According to this control, even when it is determined that the quick charge is not required based on the charge-discharge history, the quick charge reflecting the user's intention can still be performed. Therefore, in a situation that requires the quick charge, the battery pack 10 can perform the user-intention-prioritized quick charge, and in case of no user request for the quick charge, that is, when the battery pack 10 is in an auto-charge operation mode, leaving the charge determination control to a machine or a controller, extension of the battery life of the battery pack 10 is prioritized with the reduction of the quick charges to the minimum.

### SECOND EMBODIMENT

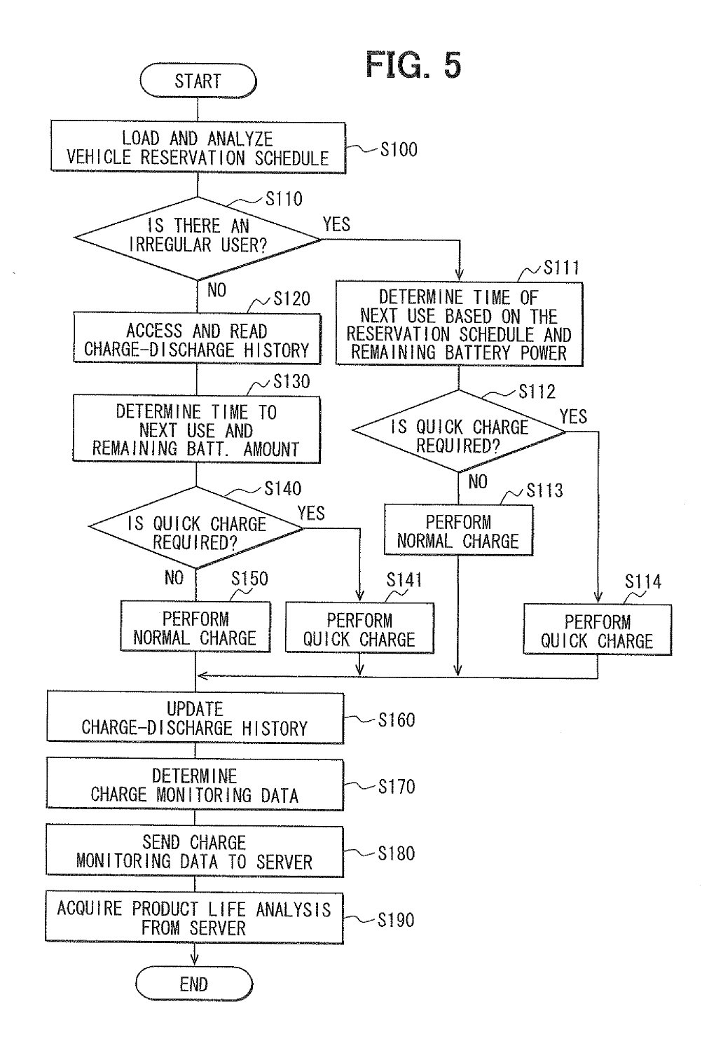

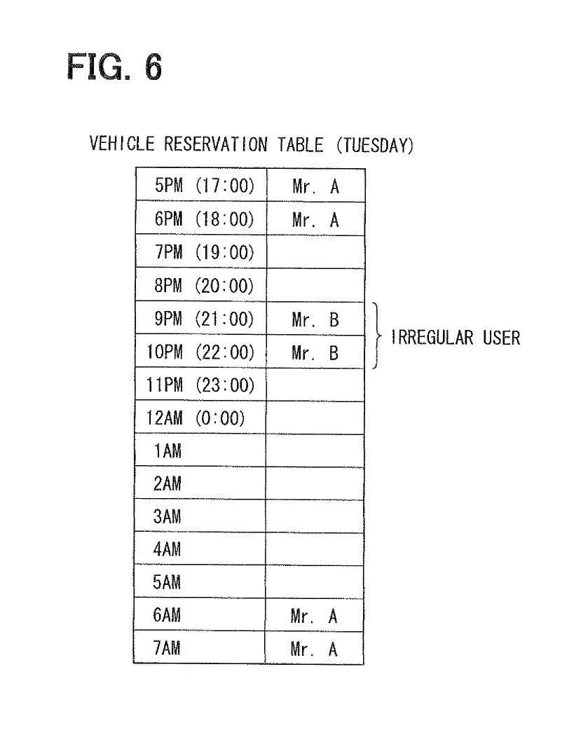

FIGS. 5 and 6 are used to explain the second embodiment, which is characterized by a different charge control than the charge control of the first embodiment. FIG. 5 is a flowchart of a control procedure performed at the time of charging the battery pack 10 in the second embodiment, and FIG. 6 is an illustration of a vehicle reservation table managed by a vehicle operation management server 22. Further, the battery pack 10, which performs the process of the second embodiment, has the same configuration as the first embodiment, as shown in FIG. 1, and has the same advantageous effects as the first embodiment.

The characteristic charge control described in the present embodiment performs, in addition to the charge control of the first embodiment, a useful charge control that handles an irregular use of the vehicle, which is not predictable from the charge-discharge history.

Each step of the flowchart in FIG. 5 is performed by the monitoring controller 11 of the battery pack 10. The process of FIG. 5, like the process in FIG. 2, is initiated when the battery cell 14 of the vehicle 1 is in a chargeable state, meaning it is about to be charged. In step S100, an operation reservation data, managed by a vehicle operation management server 22, is acquired. The vehicle operation management server 22 is an external server that is in communication with the communication unit 4 of the vehicle 1 (as shown in FIG. 1). The acquired operation reservation data may be a reservation schedule of the vehicle 1 that provides the future use of the vehicle 1 for a predetermined period of time once the current charge process is complete. For example, if the battery module 13 is being charged at 3:00 pm on a Tuesday, the reservation schedule may show the reserved use of the vehicle for each time slot during the next 24 hours.

The reservation schedule is generated and managed as data when the vehicle 1, which has the battery pack 10, is shared by multiple users. For example, the vehicle 1 may be shared by an unknown number of people who reserve the use of the vehicle 1 through a reservation system, which may be accessed through the internet, a portable terminal or the like. One example may be a car rental system. The vehicle may also be shared by a group of people such as family members, acquaintances or the like, on a first come first serve basis. In either situation, the reservation of the vehicle is secured for the first person when the desired time slot is vacant, and the reserved use right of the vehicle can only be exerted for the reserved time slot by the reserving person, as a rule.

In step S110, the acquired reservation schedule is analyzed to determine if, within the next 24 hours after the charge process is complete, the vehicle 1 is reserved for an irregular user or irregular reservation. The use of the vehicle 1 by an irregular user or regular user is provided by the vehicle operation management server 22. Based on FIG. 6, Mr. “A” is a regular user and Mr. “B” is an irregular user. Mr. “A” has reserved the vehicle 1 on Tuesday between 5:00 pm and 7:00 pm (17:00-19:00) and then again on Wednesday between 6:00 am and 8:00 am. Mr. “B” has reserved the vehicle for Tuesday from 9:00 pm to 11:00 pm (21:00-23:00).

In step S110, when it is determined that there is an irregular user, the process, in step S111 determines the amount of time between the current charge process and the next reservation, and the remaining amount of electrical charge in the battery modules 13. Based on this information, in step S111, the process determines how much time is needed to charge the battery module 13 and how much time is actually available to charge the battery module 13. Using the same analysis of step S30 of FIG. 2, the process in step S112, determines whether the quick charge required. When the quick charge is not required, the normal charge is performed in step S113 (similar to step S32 of FIG. 2). After the normal charge, the process, in step S160, records the data or information regarding the current normal charge in the charge-discharge history, and the charge-discharge history is updated (similar to step S40 of FIG. 2) In step S112, when the process determines that the quick charge is required, the quick charge is performed in step S114 (similar to step S33 of FIG. 2). After the quick charge, the process, in step S160, records the data or information regarding the current quick charge in the charge-discharge history, and the charge-discharge history is updated (similar to step S40 of FIG. 2).

For example, according to the reservation schedule in FIG. 6, the monitoring controller 11 detects the regular use of the vehicle by Mr. “A” and the irregular use by Mr. “B”. When Mr. “A” returns the vehicle 1 around 7:00 pm (19:00), and the vehicle 1 is in a chargeable state, the monitoring controller 11 detects an irregular reservation by Mr. “B” at 9:00 pm (21:00). During a regular schedule, where Mr. “B” is not on the reservation schedule, the monitoring controller 11 may be able to charge the required amount of electricity with the normal charge because the vehicle 1 would be continuously charging from the current time to 6:00 am on Wednesday, which is when Mr. “A” is scheduled to use the vehicle for a regular reservation. However, with the irregular use or irregular reservation by Mr. “B” starting at 9:00 pm (21:00), which cannot be detected by the charge discharge history but was provided by the reservation schedule, the monitoring controller 11 may determine that the required amount of electric charge needed for Mr. “B” reservation cannot be charged by the normal charge, and instead performs a quick charge. Additionally, when Mr. “B” returns the vehicle around 11:00 pm and places the vehicle in a chargeable state, the monitoring controller 11 may then determine that the amount of electric charge required for Mr. “A” regular reservation at 6:00 am cannot be charged by the normal charge, and performs the quick charge.

In step S110 of FIG. 5, if the process determines that there is no irregular reservation, the process, in step S120 (similar to step S10 of FIG. 2), accesses the charge-discharge history in the storage medium. In step S130, an analysis of the charge-discharge cycle of the charge-discharge history is performed to determine the amount of time available till the next predicted use and the amount of charge remaining in the battery module 13 (similar to step S20 of FIG. 2). For example, when the state of charge falls from 100% to 90% between a certain period of time in the charge-discharge cycle, that time period may be determined as the next planned use of the vehicle 1. Then, in step S140, it is determined whether the quick charge is required (similar to step S30 of FIG. 2).

When the quick charge is determined to be required in step S140, the quick charge is performed in step S141 (similar to step S114 of FIG. 5 and step S33 of FIG. 2), and the data about the current quick charge is recorded in the charge-discharge history in step S160, updating the charge-discharge history (similar to step S40 of FIG. 2). Further, when the quick charge is determined not to be required in step S140, the normal charge is performed in step S150, (similar to step S113 of FIGS. 5 and S32 of FIG. 2), and the data about the current normal charge is written in the charge-discharge history in step S160, and the charge-discharge history is updated (similar to step S40 of FIG. 2),

In step S170 (similar to step S50 of FIG. 2), the charge monitoring data of the battery module 13 is determined and is stored in the memory 15. In step S180 (similar to step S60 of FIG. 2), the battery pack 10 transmits the charge monitoring data, the management information, and identification ID of the battery modules 13 to the outside server 20 through the communication unit 4.

Further, in step S190 (similar to step S70 of FIG. 2), the server 20 determines and transmits the battery life prediction or the trouble prediction or the like to the battery pack 10 and/or the manufacturer 21. Then, the charge control is finished for the current cycle. By receiving the result of the analysis, the user or the manufacturer 21 is enabled to take a maintenance step such as battery replacement as required, and is enabled to secure the safe and comfortable use of the product.

Among steps in the current flowchart of the charge control, step S190 may not necessarily be performed. Even without step S190, if a trouble of the battery is found, the manufacturer 21 contacts the user for notifying him/her of the trouble and for performing the required maintenance. Further, the analysis by the server 20 regarding the battery abnormality prediction may be configured to be usable and retrievable by the manufacturer 21 at any time on demand.

Further, when the use of the vehicle by Mr. “B” from 21:00 on every Tuesday in FIG. 6 turns to be a regular reservation, the reservation schedule of the vehicle operation management server 22 is updated and the use of the vehicle by Mr. “B” is recognized as a regular reservation, not as an irregular reservation.

Further, when the use of the vehicle by Mr. “B” from 21:00 on every Tuesday in FIG. 6 turns to be a regular reservation, re-computation analysis of the battery life is enabled by an input of information such as change of use condition of the battery pack 10 into the server 20. Further, as required, the decrease of the battery life may be notified to the user, or the warning of the decreased battery life may be sent to the user.

The advantageous effects of the battery pack 10 in the present embodiment are explained in the following. The monitoring controller 11 communicates with the vehicle operation management server 22 to receive the vehicle reservation schedule regarding the future use of the vehicle 1. Then the monitoring controller 11 determines whether a quick charge is required based on the vehicle reservation schedule and the information in the charge-discharge history. In this manner, need for the quick charge can be appropriately determined even in a situation of irregular vehicle use, which cannot be determined by an analysis of the charge-discharge history.

In summary, by the monitoring controller 11 performing the analysis of the remaining battery amount and the time to the next use based on the use reservation data managed by the outside vehicle operation management server 22 in step S111, the quick charge is determined either to be required or not.

According to such control, the normal charge is determined to be performed when the required amount of electricity can be charged in the battery by the time of the next planned use, and the quick charge is determined to be performed when the time to the next planned use is not sufficient for charging the required amount of electricity in the battery. In this manner, both of the regular and irregular use of the vehicle, which can or cannot be predicted based on the charge-discharge history, can respectively be handled in an appropriate manner, by performing the quick charge only for the required time or by preventing the unnecessary quick charge.

### OTHER EMBODIMENTS

Although the present disclosure has been fully described in connection with preferred embodiment thereof with reference to the accompanying drawings, it is to be noted that various changes and modifications will become apparent to those skilled in the art.

For example, the charge-discharge history may not initially have any data, and may start to store data at the time of first charging of the battery pack 10, and the data may be updated at every charge and discharge, or, the charge-discharge history may have a standard history (i.e., a default data) to start with, which may be updated at every charge and discharge.

The charge station 30 may not have a data communication equipment. When the charge station does not have a data communication equipment, the intelligent battery pack of the present disclosure is still capable of storing data regarding charge and discharge.

The vehicular battery pack may be charged by a device that does not have any physical contact portion, That is, a charge coil of the charger may be employed to wirelessly charge the battery pack. When the battery pack is charged wirelessly, the vehicle carrying the battery pack may be stopped in a position at the charge station to bring an electricity reception portion of the vehicle facing to the charge coil of the charger in the charge station.

The vehicular battery pack may be usable to wide variety of vehicles as long as vehicles are driven by an electrical charge in a battery. That is, for example, a hybrid vehicle may be driven by the electric charge in the battery, which is charged by using a power of an internal combustion engine converted to the electricity.

The memory 15 disposed in each of the battery modules 13 may store the management information of the whole battery pack 10, instead of the management information of the each of the battery modules 13. The management information of such configuration may include a warranty period, a charge condition, and a discharge condition of the whole battery pack 10.

Each of the battery modules 13 may be configured to include a single battery cell 14, or may configured to include many, i.e., multiple, battery cells 14. Further, the manufacturer 21 may be a manufacturer of the battery cell 14 or the like, or may be a manufacturer of the battery pack 10, or may be a manufacturer of the vehicle 1.

Such changes, modifications, and summarized scheme are to be understood as being within the scope of the present disclosure as defined by appended claims.

What is claimed is:

1. A vehicular battery pack comprising:
a battery that provides electric power to a vehicle;
a control unit that stores a charge record and a discharge record in a charge-discharge history of the battery, and the control unit determines a charge operation of the battery based on an analysis of the charge-discharge history; and
wherein the control unit determines the charge operation to either be a normal charge or a quick charge, the quick charge is different from the normal charge, and the normal charge provides a charging electric current per unit time that is less than the charging current per unit time of the quick charge.

2. The vehicular battery pack of claim 1, wherein
the control unit at least communicates with a vehicle operation management server that manages an operation reservation data regarding a future operation of the vehicle, and
the control unit analyzes the charge-discharge history and the operation reservation data acquired from the vehicle operation management server in order to determine the charge operation.

3. The vehicular battery pack of claim 2, wherein the control unit determines whether the quick charge is required based on an analysis of (a) time to a next planned use according to the operation reservation data and (b) a remaining electric charge in the battery.

4. The vehicular battery pack of claim 1, wherein the control unit transmits a charge monitoring data to a responsible organization, wherein the responsible organization determines a degree of degradation of the battery.

5. The vehicular battery pack of claim 1, wherein the control unit performs the quick charge upon acquiring a quick charge request from a user of the vehicle, even when the control unit determines that the quick charge is not required.
